(19) United States
(12) Patent Application Publication
(10) Pub. No.: US 2011/0279445 A1
(43) Pub. Date: Nov. 17, 2011

(54) METHOD AND APPARATUS FOR PRESENTING LOCATION-BASED CONTENT

(75) Inventors: David Joseph Murphy, Helsinki (FI); Brenda Castro, Helsinki (FI); Tuomas Vaittinen, Helsinki (FI); Tuula Karkkainen, Tampere (FI); Ari Antero Aarnio, Espoo (FI)

(73) Assignee: Nokia Corporation, Espoo (FI)

(21) Appl. No.: 12/780,912

(22) Filed: May 16, 2010

(51) Int. Cl. G06T 15/00; G06F 3/048; G06F 17/30

(52) U.S. Cl. 345/419; 707/705; 715/764; 707/E17.009

(57) ABSTRACT

An approach is provided for rendering content associated with a location-based service. Content is retrieved that is associated with a point on an object identified in the location-based service. The object can be represented by, but is not limited to, a three-dimensional or two-dimensional model or models or by an augmented reality view. A model of the object is retrieved. Rendering of the content is caused, at least in part, on one or more surfaces of the object model in a user interface of the location-based service.

### BACKGROUND

Service providers and device manufacturers (e.g., wireless, cellular, etc.) are continually challenged to deliver value and convenience to consumers by, for example, providing compelling network services. One area of interest has been the development of location-based services (e.g., navigation services, mapping services, augmented reality applications, etc.) which have greatly increased in popularity, functionality, and content. However, with this increase in the available content and functions of these services, service providers and device face significant technical challenges to presenting the content in ways that can be easily and quickly understood by a user.

### SOME EXAMPLE EMBODIMENTS

Therefore, there is a need for an approach for efficiently and effectively presenting location-based content to users.

According to one embodiment, a method comprises retrieving content associated with one or more points on one or more objects of a location-based service. The method also comprises retrieving one or more models of the one or more objects. The method further comprises causing, at least in part, rendering of the content associated with one or more surfaces of the one or more object models in a user interface of the location-based service.

According to another embodiment, an apparatus comprising at least one processor, and at least one memory including computer program code, the at least one memory and the computer program code configured to, with the at least one processor, cause, at least in part, the apparatus to retrieve content associated with one or more points on one or more objects of a location-based service. The apparatus is also caused to retrieve one or more models of the one or more objects. The apparatus is further causes, at least in part, rendering of the content associated with one or more surfaces of the one or more object models in a user interface of the location-based service.

According to another embodiment, a computer-readable storage medium carrying one or more sequences of one or more instructions which, when executed by one or more processors, cause, at least in part, an apparatus to retrieve content associated with one or more points on one or more objects of a location-based service. The apparatus is also caused to retrieve one or more models of the one or more objects. The apparatus is further causes, at least in part, rendering of the content associated with one or more surfaces of the one or more object models in a user interface of the location-based service.

According to another embodiment, an apparatus comprises means for retrieving content associated with one or more points on one or more objects of a location-based service. The apparatus also comprises means for retrieving one or more models of the one or more objects. The apparatus further comprises means for causing, at least in part, rendering of the content associated with one or more surfaces of the one or more object models in a user interface of the location-based service.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of presenting a user interface with content rendered based on one or more surfaces of an object model, according to one embodiment;

FIG. 2 is a diagram of the components of user equipment, according to one embodiment;

FIG. 3 is a flowchart of a process for presenting a user interface with content rendered based on one or more surfaces of an object model, according to one embodiment;

FIG. 4 is a flowchart of a process for associating content with a point of an object model, according to one embodiment;

FIG. 5 is a flowchart of a process for recommending a perspective to a user for viewing content, according to one embodiment;

FIGS. 6A-6D are diagrams of user interfaces utilized in the processes of FIG. 3, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for presenting a user interface with content rendered based on one or more surfaces of an object model are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

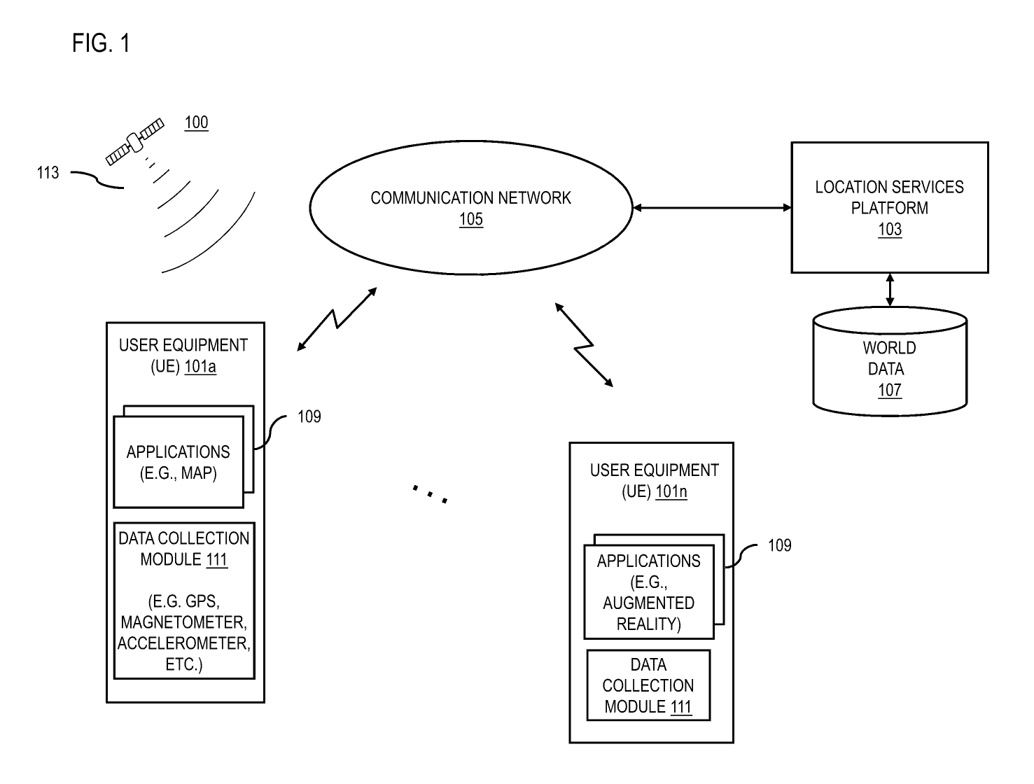

FIG. 1 is a diagram of a system capable of presenting a user interface with content rendered based on one or more surfaces of an object model, according to one embodiment. It is noted that mobile devices and computing devices in general are becoming ubiquitous in the world today and with these devices, many services are being provided. These services can include augmented reality (AR) and mixed reality (MR), services and applications. AR allows a user's view of the real world to be overlaid with additional visual information. MR allows for the merging of real and virtual worlds to produce visualizations and new environments. In MR, physical and digital objects can co-exist and interact in real time. Thus, MR can be a mix of reality, AR, virtual reality, or a combination thereof.

A benefit of using such applications allows for the association of content to a location. This content may be shared with others or kept for a user to remind the user of information. Typically, the more precise a location is defined, the more useful the location based content. As such, technical challenges arise in determining and associating content with a particular location. Further, technical challenges arise in retrieving the associated content for presentation to the user or other users. By way of example, many traditional mobile AR services use sensors and location information to display content on top of a camera view with the results being icons or text boxes floating or trembling over the camera view. This association between content and context is not very precise, which may cause the user to believe that content is associated with a location that the content is not associated with or may otherwise make determining the association difficult. Further, there is lack of integration between the content and the environment. Instead, the user merely sees an overlay of content on top of a camera feed. Moreover, many of these AR services often display content on top of a scene in a manner that makes it difficult to associate visually with the exact place that the content belongs to. In some cases, information presented via the overlay corresponds to a place or point that is obstructed by another object (e.g., a building, a tree, other visual elements, etc.).

To address these problems, a system 100 of FIG. 1 introduces the capability to present a user interface with content rendered based on one or more surfaces of an object model. In one embodiment, images (e.g., panoramic images) can be utilized to mix AR with virtual reality (VR) to help a user to more clearly understand where augmented content is associated. A graphical user interface (GUI) for presenting the content can include attaching the content to a scene (e.g., a portion of a panoramic image, a portion of a camera view, etc.) by utilizing object models (e.g., building models, tree models, street models, wall models, landscape models, and models of other objects). According to one embodiment, an object can be a representation (e.g., a two dimensional or three dimensional representation) of a physical object in the real world or physical environment, or a corresponding virtual object in a virtual reality world. A representation of a physical object can be via an image of the object. With this approach users can view where the content is associated as it is displayed over a view (e.g., a panoramic view and/or camera view) as the information of the location associated with the object model is represented in the GUI.

For example, if the user generates a note associated with a fifth floor of a building, the note can be presented on top of that fifth floor. Further, a three dimensional (3D) perspective can be utilized that makes the content become part of the view instead of an overlay of it. In this manner, the content can be integrated with a surface (e.g., a building facade) of the object model. To present such a GUI, user equipment (UE) 101 can retrieve content associated with a point on an object of a location-based service. The UE 101 can then retrieve a model of the object and cause rendering of the content based on one or more surfaces of the object model in the GUI.

In one embodiment, user equipment 101a-101n of FIG. 1 can present the GUI to users. In certain embodiments, the processing and/or rendering of the images may occur on the UE 101. In other embodiments, some or all of the processing may occur on one or more location services platforms 103 that provide one or more location-based services. In certain embodiments, a location-based service is a service that can provide information and/or entertainment based, at least in part, on a geographical position. In certain embodiments, the location-based service can be based on location information and/or orientation information of the UE 101. Examples of location services include navigation, map services, local searching, AR, etc. The UE 101 and the location services platform 103 can communicate via a communication network 105. In certain embodiments, the location services platform 103 may additionally include world data 107 that can include media (e.g., video, audio, images, etc.) associated with particular locations (e.g., location coordinates in metadata). This world data 107 can include media from one or more users of UEs 101 and/or commercial users generating the content. In one example, commercial and/or individual users can generate panoramic images of area by following specific paths or streets. These panoramic images may additionally be stitched together to generate a seamless image. Further, panoramic images can be used to generate images of a locality, for example, an urban environment such as a city. In certain embodiments, the world data 107 can be broken up into one or more databases.

Moreover, the world data 107 can include map information. Map information may include maps, satellite images, street and path information, point of interest (POI) information, signing information associated with maps, objects and structures associated with the maps, information about people and the locations of people, coordinate information associated with the information, etc., or a combination thereof. A POI can be a specific point location that a person may, for instance, find interesting or useful. Examples of POIs can include an airport, a bakery, a dam, a landmark, a restaurant, a hotel, a building, a park, the location of a person, or any point interesting, useful, or significant in some way. In some embodiments, the map information and the maps presented to the user may be a simulated 3D environment. In certain embodiments, the simulated 3D environment is a 3D model created to approximate the locations of streets, buildings, features, etc. of an area. This model can then be used to render the location from virtually any angle or perspective for display on the UE 101. Further, in certain embodiments, the GUI presented to the user may be based on a combination of real world images (e.g., a camera view of the UE 101 or a panoramic image) and the 3D model. The 3D model can include one or more 3D object models (e.g., models of buildings, trees, signs, billboards, lampposts, etc.). These 3D object models can further comprise one or more other component object models (e.g., a building can include four wall component models, a sign can include a sign component model and a post component model, etc.). Each 3D object model can be associated with a particular location (e.g., global positioning system (GPS) coordinates or other location coordinates, which may or may not be associated with the real world) and can be identified using one or more identifier. A data structure can be utilized to associate the identifier and the location with a comprehensive 3D map model of a physical environment (e.g., a city, the world, etc.). A subset or the set of data can be stored on a memory of the UE 101.

The user may use an application 109 (e.g., an augmented reality application, a map application, a location services application, etc.) on the UE 101 to provide content associated with a point on an object to the user. In this manner, the user may activate a location services application 109. The location services application 109 can utilize a data collection module 111 to provide location and/or orientation of the UE 101. In certain embodiments, one or more GPS satellites 113 may be utilized in determining the location of the UE 101. Further, the data collection module 111 may include an image capture module, which may include a digital camera or other means for generating real world images. These images can include one or more objects (e.g., a building, tree, sign, car, truck, etc.). Further, these images can be presented to the user via the GUI. The UE 101 can determine a location of the UE 101, an orientation of the UE 101, or a combination thereof to present the content and/or to add additional content.

For example, the user may be presented a GUI including an image of a location. This image can be tied to the 3D world model (e.g., via a subset of the world data 107). The user may then select a portion or point on the GUI (e.g., using a touch enabled input). The UE 101 receives this input and determines a point on the 3D world model that is associated with the selected point. This determination can include the determination of an object model and a point on the object model and/or a component of the object model. The point can then be used as a reference or starting position for the content. Further, the exact point can be saved in a content data structure associated with the object model. This content data structure can include the point, an association to the object model, the content, the creator of the content, any permissions associated with the content, etc.

Permissions associated with the content can be assigned by the user, for example, the user may select that the user's UE 101 is the only device allowed to receive the content. In this scenario, the content may be stored on the user's UE 101 and/or as part of the world data 107 (e.g., by transmitting the content to the location services platform 103). Further, the permissions can be public, based on a key, a username and password authentication, based on whether the other users are part of a contact list of the user, or the like. In these scenarios, the UE 101 can transmit the content information and associated content to the location services platform 103 for storing as part of the world data 107 or in another database associated with the world data 107. As such, the UE 101 can cause, at least in part, storage of the association of the content and the point. In certain embodiments, content can be visual or audio information that can be created by the user or associated by the user to the point and/or object. Examples of content can include a drawing starting at the point, an image, a 3D object, an advertisement, text, comments to other content or objects, or the like.

In certain embodiments, the content and/or objects presented to the user via the GUI is filtered. Filtering may be advantageous if more than one content is associated with an object and/or objects presented on the GUI. Filtering can be based on one or more criteria. One criterion can include user preferences, for example, a preference selecting types (e.g., text, video, audio, images, messages, etc.) of content to view or filter, one or more content providers (e.g., the user or other users) to view or filter, etc. Another criterion for filtering can include removing content from display by selecting the content for removal (e.g., by selecting the content via a touch enabled input and dragging to a waste basket). Moreover, the filtering criteria can be adaptive using an adaptive algorithm that changes behavior based on information available. For example, a starter set of information or criteria (e.g., selected content providers can be viewed) and based on the starter set, the UE 101 can determine other criteria (e.g., other content providers that are similar) based on the selected criteria. In a similar manner, the adaptive algorithm can take into account content removed from view on the GUI. Additionally or alternatively, precedence on viewing content that overlaps can be determined and stored with the content. For example, an advertisement may have the highest priority to be viewed because a user has paid for the priority. Then, criteria can be used to sort priorities of content to be presented to the user in a view. In certain embodiments, the user may be provided the option to filter the content based on time. By way of example, the user may be provided a scrolling option (e.g., a scroll bar) to allow the user to filter content based on the time it was created or associated with the environment. Moreover, if content that the user wishes to view is obstructed, the UE 101 can determine and recommend another perspective to more easily view the content as further detailed in FIG. 5.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101 and the location services platform 103, communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the location services platform 103 may interact according to a client-server model with the applications 109 of the UE 101. According to the client-server model, a client process sends a message including a request to a server process, and the server process responds by providing a service (e.g., augmented reality image processing, augmented reality image retrieval, messaging, 3D map retrieval, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

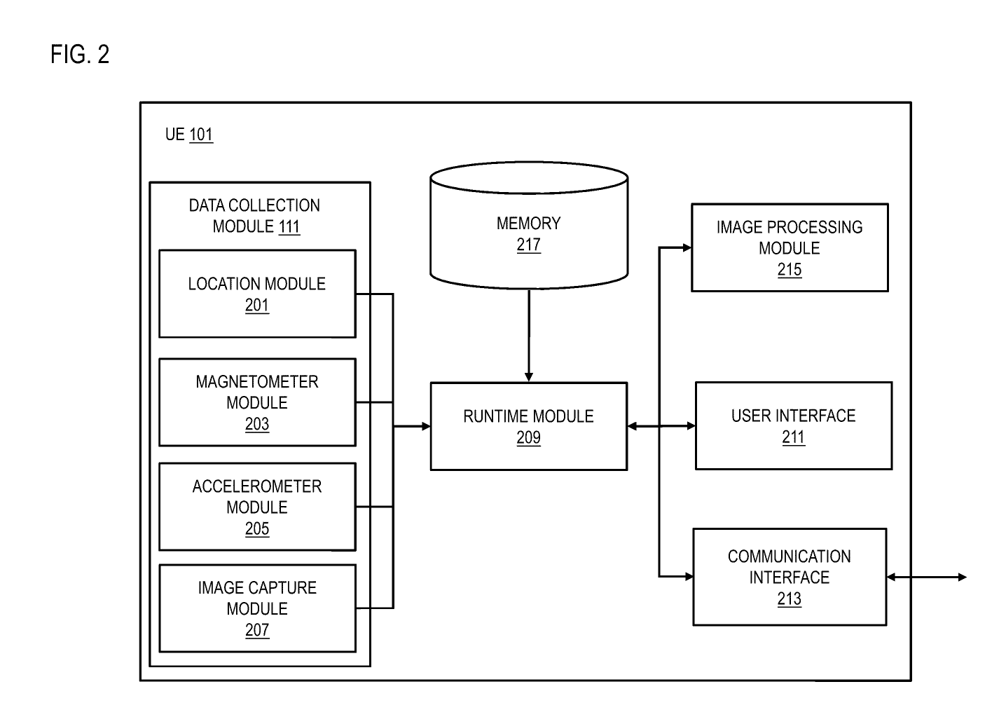

FIG. 2 is a diagram of the components of user equipment, according to one embodiment. By way of example, a UE 101 includes one or more components for providing a GUI with content rendered based on one or more surfaces of an object model. It is contemplated that the functions of these components may be combined in one or more components or performed by other components of equivalent functionality. In this embodiment, the UE 101 includes a data collection module 111 that may include one or more location modules 201, magnetometer modules 203, accelerometer modules 205, image capture modules 207, the UE 101 can also include a runtime module 209 to coordinate use of other components of the UE 101, a user interface 211, a communication interface 213, an image processing module 215, and memory 217. An application 109 (e.g., the location services application) of the UE 101 can execute on the runtime module 209 utilizing the components of the UE 101.

The location module 201 can determine a user's location. The user's location can be determined by a triangulation system such as GPS, assisted GPs (A-GPS), Cell of Origin, or other location extrapolation technologies. Standard GPS and A-GPS systems can use satellites 113 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are embedded into metadata of captured media (e.g., images, video, etc.) or otherwise associated with the UE 101 by the application 109. Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer is embedded into the metadata of captured or streaming media or otherwise associated with the UE 101 (e.g., by including the information in a request to a location services platform 103) by the location services application 109. The request can be utilized to retrieve one or more objects and/or images associated with the location.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In one embodiment, vertical directional data obtained from an accelerometer is embedded into the metadata of captured or streaming media or otherwise associated with the UE 101 by the location services application 109. In certain embodiments, the magnetometer module 203 and accelerometer module 205 can be means for ascertaining a perspective of a user. Further, the orientation in association with the user's location can be utilized to map one or more images (e.g., panoramic images and/or camera view images) to a 3D environment.

In one embodiment, the communication interface 213 can be used to communicate with a location services platform 103 or other UEs 101. Certain communications can be via methods such as an internet protocol, messaging (e.g., SMS, MMS, etc.), or any other communication method (e.g., via the communication network 105). In some examples, the UE 101 can send a request to the location services platform 103 via the communication interface 213. The location services platform 103 may then send a response back via the communication interface 213. In certain embodiments, location and/or orientation information is used to generate a request to the location services platform 103 for one or more images (e.g., panoramic images) of one or more objects, one or more map location information, a 3D map, etc.

The image capture module 207 can be connected to one or more media capture devices. The image capture module 207 can include optical sensors and circuitry that can convert optical images into a digital format. Examples of image capture modules 207 include cameras, camcorders, etc. Moreover, the image capture module 207 can process incoming data from the media capture devices. For example, the image capture module 207 can receive a video feed of information relating to a real world environment (e.g., while executing the location services application 109 via the runtime module 209). The image capture module 207 can capture one or more images from the information and/or sets of images (e.g., video). These images may be processed by the image processing module 215 to include content retrieved from a location services platform 103 or otherwise made available to the location services application 109 (e.g., via the memory 217). The image processing module 215 may be implemented via one or more processors, graphics processors, etc. In certain embodiments, the image capture module 207 can be a means for determining one or more images.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Moreover, the user interface 211 may be used to display maps, navigation information, camera images and streams, augmented reality application information, POIs, virtual reality map images, panoramic images, etc. from the memory 217 and/or received over the communication interface 213. Input can be via one or more methods such as voice input, textual input, typed input, typed touch-screen input, other touch-enabled input, etc. In certain embodiments, the user interface 211 and/or runtime module 209 can be means for causing rendering of content on one or more surfaces of an object model.

Further, the user interface 211 can additionally be utilized to add content, interact with content, manipulate content, or the like. The user interface may additionally be utilized to filter content from a presentation and/or select criteria. Moreover, the user interface may be used to manipulate objects. The user interface 211 can be utilized in causing presentation of images, such as a panoramic image, an AR image, an MR image, a virtual reality image, or a combination thereof. These images can be tied to a virtual environment mimicking or otherwise associated with the real world. Any suitable gear (e.g., a mobile device, augment reality glasses, projectors, etc.) can be used as the user interface 211. The user interface 211 may be considered a means for displaying and/or receiving input to communicate information associated with an application 109.

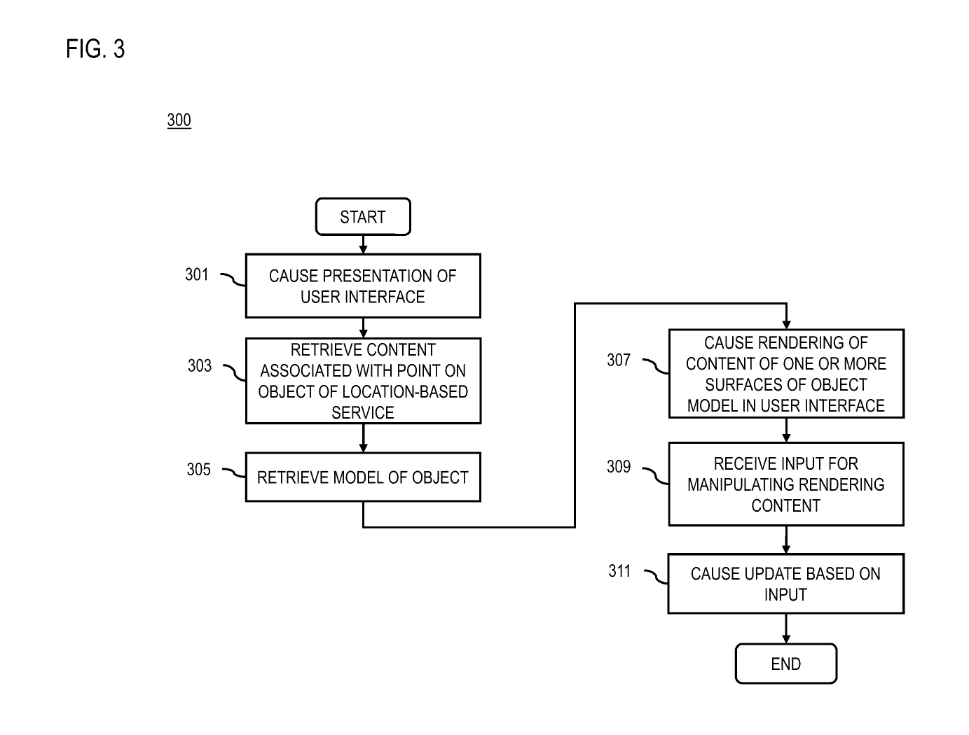

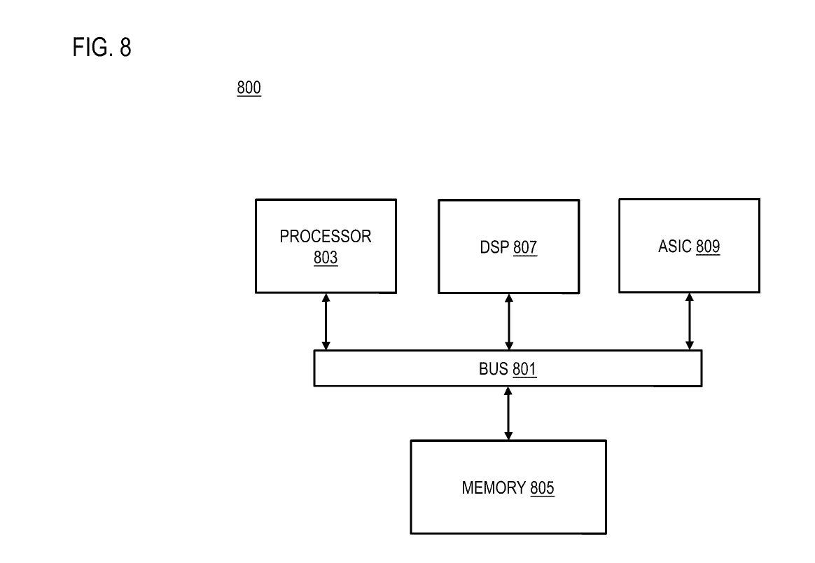

FIG. 3 is a flowchart of a process for presenting a user interface with content rendered based on one or more surfaces of an object model, according to one embodiment. In one embodiment, the location services application 109 performs the process 300 and is implemented in, for instance, a chip set including a processor and a memory as shown in FIG. 8. As such, the location services application 109 and/or the runtime module 209 can provide means for accomplishing various parts of the process 300 as well as means for accomplishing other processes in conjunction with other components of the UE 101 and/or location services platform 103.

In step 301, the location services application 109 causes, at least in part, presentation of a graphical user interface. The GUI can be presented to the user via a screen of the UE 101. The GUI can be presented based on a start up routine of the UE 101 or the location services application 109. Additionally or alternatively, the GUI can be presented based on an input from a user of the UE 101. In certain embodiments, the GUI can include one or more streaming image capture images (e.g., a view from a camera) and/or one or more panoramic images. The panoramic images can be retrieved from memory 217 and/or from the location services platform 103. A retrieval from the location services platform 103 can include a transmission of a request for the images and a receipt of the images. Further, the location services application 109 can retrieve one or more objects from the location services platform 103 (e.g., from the world data 107). The retrieval of the objects and/or panoramic images can be based on a location. This location can be determined based on the location module 201 and/or other components of the UE 101 or based on input by the user (e.g., entering a zip code and/or address). From the location, the user is able to view the images and/or objects.

Then, at step 303, the location services application 109 can retrieve content associated with one or more points of one or more objects of a location-based service provided by the location services application 109. The retrieval of content can be triggered by a view of the GUI. For example, when the user's view includes an object and/or an image with associated content, the content can be retrieved. Once again, this content can be retrieved from the memory 217 of the UE 101 or the world data 107. Moreover, the UE 101 can retrieve one or more models of the objects (step 305). The models can include a 3D model associated with an object of a virtual 3D map or a model of a component of the object (e.g., a component object such as a wall of a building).

Next, at step 307, the location services application 109 can cause, at least in part, rendering of the content based on one or more surfaces of the object model(s) in the GUI of the location-based service. The rendering can additionally overlay the content as a skin on top of the model. Further, the rendering can overlay the content over a skin of an image on top of the model. In certain embodiments, the model need not be presented, but the surface can be determined based on information stored in a database (e.g., the world data 107). Rendering on the surface of an object can further be used for integration of the object and the content, thus providing a more precise viewing of associations between the content and associated object.

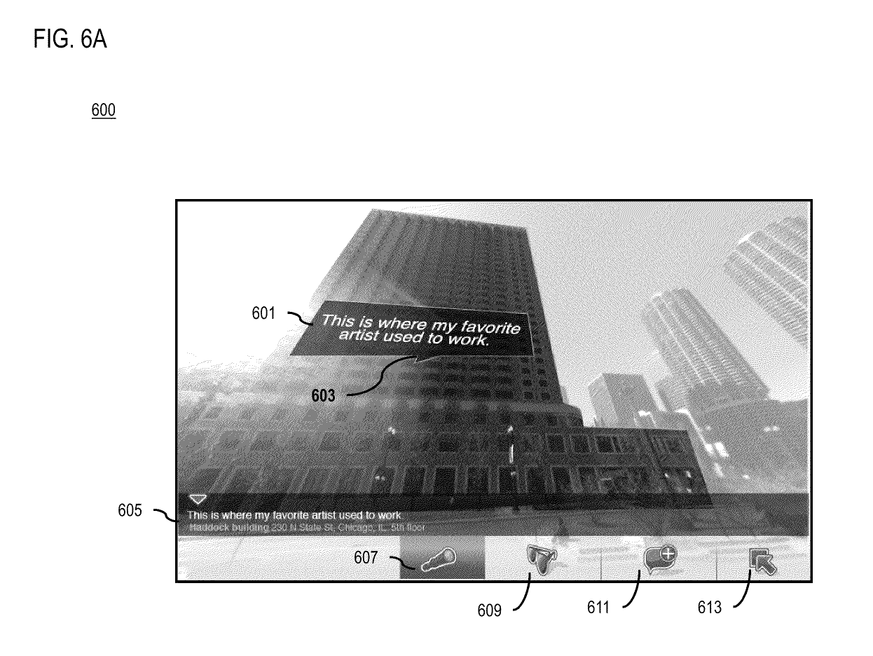

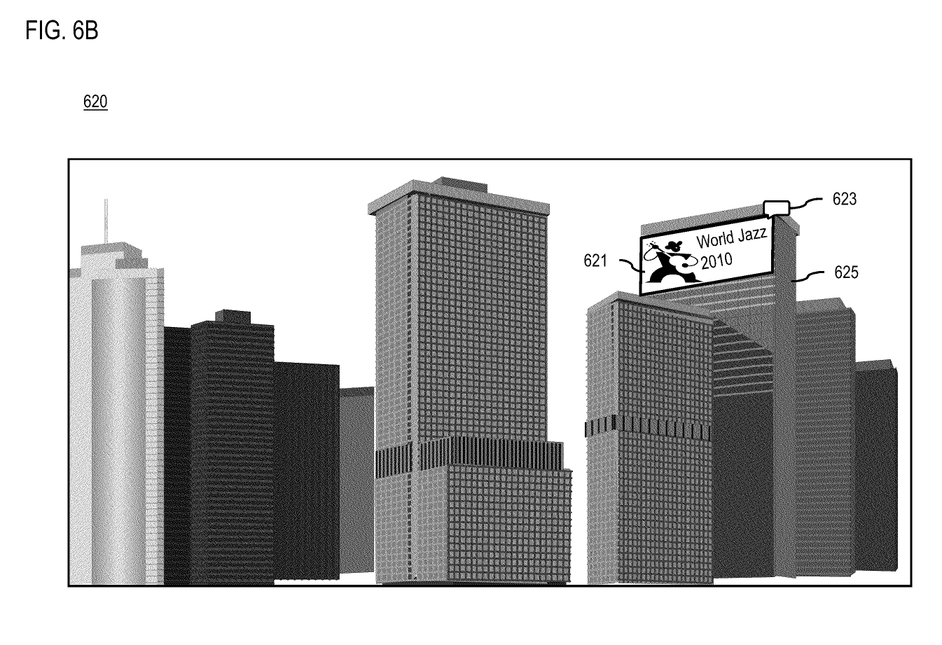

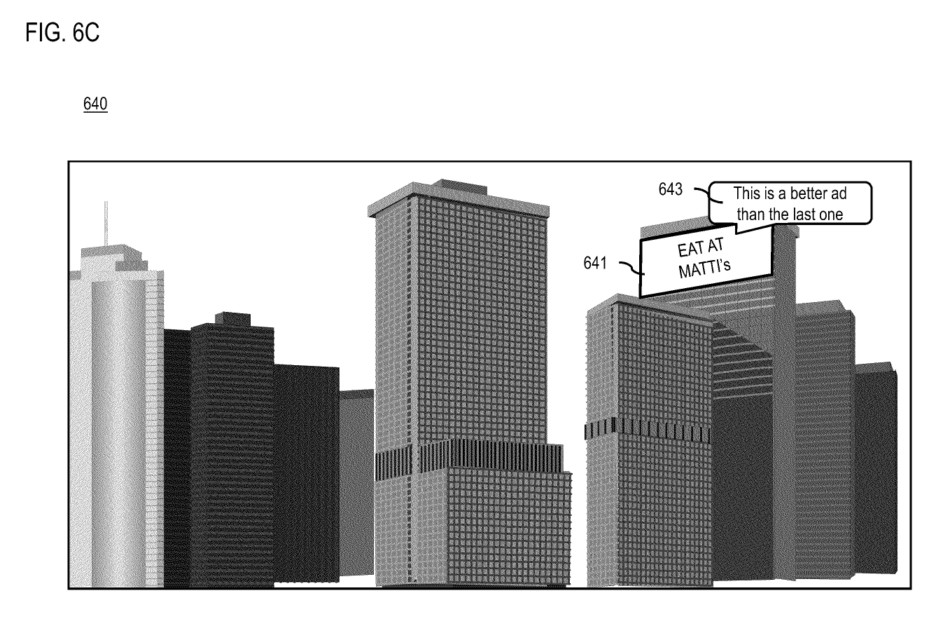

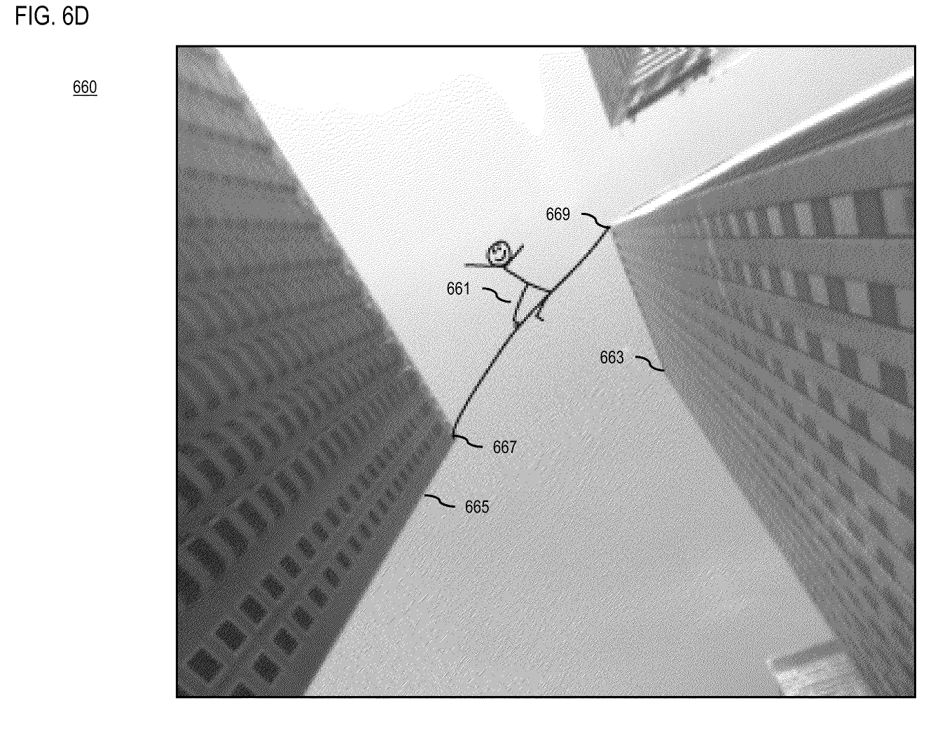

Moreover, the rendered content can be presented via the GUI. Further, the presentation can include information regarding the location of the content based on the point(s). For example, the location information can include a floor associated with a building on which the content is associated with. In another example, the location information can include an altitude or internal building information. Further, this information can be presented as an icon, a color, one or more numbers on a map representation of the object, etc. as further detailed in FIG. 6A. The location information can be based on an association of the object model with the point. For example, the point can be associated with a volume (e.g., one or more sets of points) of the object model that is part of an area (e.g., the tenth floor).

By way of example, the object model, one or more other object models, or a combination thereof can comprise a 3D model corresponding to a geographic location. The rendering can include one or more images over the 3D model in the user interface. As previously noted, the 3D model can include a mesh and the images can be skin over the mesh. This mesh and skin model can provide a more realistic view on the GUI. Further, the images can include panoramic images, augmented reality images (e.g., via a camera), a mixed reality image, a virtual reality image, or a combination thereof.

As previously noted, the rendering of the content can include filtering which content and other GUI information is provided to the user. As such, the location services application 109 can cause, at least in part, filtering of the content, the object model(s), the point(s), one or more other object models, one or more other content, or a combination thereof based on one or more criteria. As noted previously, the criteria can include user preferences, criteria determined based on an algorithm, criteria for content sorted based on one or more priorities, criteria determined based on input (e.g., drag to a waste bin), etc. The rendering of the user interface can be updated based on such filtering (e.g., additional content may be presented as the content is filtered out).

In certain embodiments, the rendering of the content can be based on 3D coordinates of the content. One or more 3D coordinates for rendering the content can be determined relative to one or more other 3D coordinates corresponding to one or more object models. In one example, the content is associated with the one or more content models, one or more points, one or more other points within the volume of the one or more objects, or a combination thereof. The association can be based, at least in part, on the one or more 3D coordinates.

In one scenario, the 3D coordinates can be specific to the 3D environment (e.g., a macro view of the environment). In another scenario, the 3D coordinates can be relative to the object model (e.g., a micro view of the environment). In the ladder scenario, the 3D coordinates may be dependent on the object model. Further, the model can be associated with its own 3D coordinates in the 3d environment.

At step 309, the location services application 109 receives input for manipulating the rendering of the content. This input can include a selection of the content and an option to alter or augment the content. This option can be provided to the user based on a permission associated with the content. For example, if the content requires a certain permission to alter the content, the user may be required to provide authentication information to update the content. The content can be manipulated by changing text associated with the content, a location or point(s) associated with the content, commenting on the content, removing part of the content, replacing the content (e.g., replace a video with an image, another video, etc.), a combination thereof, etc.

Then, at step 311, an update of the content, the point(s), the object model(s), an association between the point and the content, a combination thereof, etc. is caused. The update can include updating a local memory 217 of the UE 101 with the information, updating world data 107 by causing transmission of the update, or updating other UEs 101 by causing transmission of the update to the UEs 101. For example, the user may know of other users who may wish to see the update. The update can be sent to UEs 101 of those users (e.g., via a port on the other users' UEs 101 associated with a location services application 109 of the other users' UEs 101). Moreover, when the content is updated, an update log and/or history can be updated. Further the original content, object model(s), point(s), etc. can be caused to be archived for later retrieval.

In one embodiment, the location services application 109 causes presentation of the content based on a perspective of the user interface in relation to the content. A determination of the perspective of the user interface in relation to the content can be made. This determination can take into account a view of the content as compared to the view of the user. For example, this determination can be based on angle at which the content would be presented to the user. If the content is within a threshold viewing angle, a transformation can be caused, at least in part, of the rendering of the content based on the viewing angle. The transformation can provide a better viewing angle of the content. In one example, the transformation brings the content into another view that is more easily viewable by the user.

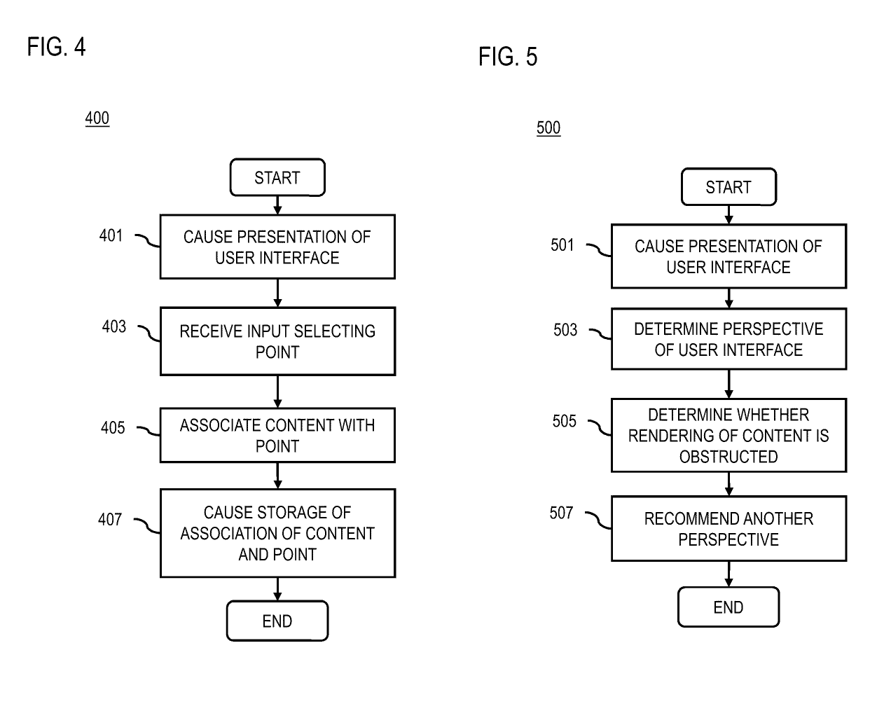

FIG. 4 is a flowchart of a process for associating content with a point of an object model, according to one embodiment. In one embodiment, the location services application 109 performs the process 400 and is implemented in, for instance, a chip set including a processor and a memory as shown in FIG. 8. As such, the location services application 109 and/or the runtime module 209 can provide means for accomplishing various parts of the process 400 as well as means for accomplishing other processes in conjunction with other components of the UE 101 and/or location services platform 103.

At step 401, the location services application 109 causes, at least in part, presentation of a graphical user interface. As noted in step 301, the GUI can be presented to the user via a screen of the UE 101. Further, the GUI can present a view of the location services application 109. For example, the GUI can include one of the user interfaces described in FIGS. 6A-6D.

Based on the user interface, the user can select a point or multiple points on the GUI (e.g., via a touch enabled input). The location services application 109 receives the input for selecting the point(s) via the user interface (step 403). As noted above the input can be via a touch enabled input, a scroll and click input, or any other input mechanism. The point(s) selected can be part of a 3D virtual world model, a camera view, a panoramic image set, a combination thereof, etc. presented on the GUI.

Then, at step 405, the location services application 109 associates content with the point. The user can select the content from information in memory 217 or create the content (e.g., via a drawing tool, a painting tool, a text tool, etc.) of the location services application 109. Further, the content retrieved from the memory 217 can include one or more media objects such as audio, video, images, etc. The content may be associated with the point by associating the selected point with a virtual world model. In this scenario, the virtual world model can include one or more objects and object models (e.g., a building, a plant, landscape, streets, street signs, billboards, etc.). These objects can be identified in a database based on an identifier and/or a location coordinate. Further, when the GUI is presented, the GUI can include the virtual world model in the background to be used to select points. The user may change between various views while using the location services application 109. For example, a first view may include a two dimensional map of an area, a second view may include a 3D map of the area, and a third view may include a panoramic or camera view of the area.

In certain embodiments, the virtual world model (e.g., via a polygon mesh) is presented on the GUI and the panoramic and/or camera view is used as a skin on the polygon mesh. In other embodiments, the camera view and/or panoramic view can be presented and the objects can be associated in the background based on the selected point. When the point is selected, it can be mapped onto the associated object of the background and/or the virtual world model. Further, the content can be selected to be stored for presentation based on the selected point. For example, the selected point can be a corner, a starting point, the middle, etc. of the content.

At step 407, the location services application 109 can cause, at least in part, storage of the association of the content and the point. The storage can be via the memory 217. In other embodiments, the storage can be via the world data 107. As such, the location services application 109 causes transmission of the information to the location services platform 103, which causes storage in a database. In other embodiments, the location services application 109 can cause transmission of the associated content and point (e.g., by sending a data structure including the content and point) to one or more other UEs 101, which can then utilize the content. Further, as noted above, the storage can include creating and associating permissions to the content.

FIG. 5 is a flowchart of a process for recommending a perspective to a user for viewing content, according to one embodiment. In one embodiment, the location services application 109 performs the process 500 and is implemented in, for instance, a chip set including a processor and a memory as shown in FIG. 8. As such, the location services application 109 and/or the runtime module 209 can provide means for accomplishing various parts of the process 500 as well as means for accomplishing other processes in conjunction with other components of the UE 101 and/or location services platform 103.

At step 501, the location services application 109 causes, at least in part, presentation of a GUI. As noted in steps 301 and 401, the GUI can be presented to the user via a screen of the UE 101. Further, the GUI can present a view of the location services application 109. For example, the GUI can include one of the user interfaces described in FIGS. 6A-6D.

Then, at step 503, the location services application 109 determines a perspective of the user interface. The perspective can be based on a location of the UE 101 (e.g., based on location coordinates, an orientation of the UE 101, or a combination thereof), a selected location (e.g., via a user input), etc. A user input including such a selection can include a street address, a zip code, zooming in and out of a location, dragging a current location to another location, etc. The virtual world and/or panorama views can be utilized to provide image information to the user.

At step 505, the location services application 109 determines whether the rendering of the content is obstructed by one or more renderings of other object models on the user interface. For example, if content available to the user is associated with a wall object on the other side of a building the user is viewing. In this scenario, a cue to the content can be presented to the user. Such a cue can include a visual cue such as visual hint, a map preview, a tag, a cloud, an icon, a pointing finger, etc. Moreover, in certain scenarios, the content can be searched for to be viewed. For example, the content can include searchable metadata including tags or text describing the content.

If the content is obstructed, the location services application 109 can recommend another perspective based, at least in part, on the determination with respect to the obstruction (step 507). The visual cue can be selected (e.g., by being in view) and the location services application 109 can provide an option to view the content in another perspective. The other perspective can be determined by determining a point and/or location associated with the content. Then, the location services application 109 can determine a face or surface associated with the content. This face can be brought into view e.g., by zooming out from a view facing the content. Moreover, in certain embodiments, the user can navigate to the other perspective (e.g., by selecting movement options available via the user interface). Such movement options can include moving, rotating, dragging to get to content, etc.

FIGS. 6A-6D are diagrams of user interfaces utilized in the processes of FIGS. 3-5, according to various embodiments. User interface 600 shows a view of a location services application 109. Content 601 can be shown to the user. In one embodiment, the content 601 can be added by the user. As such, the user can select a particular point 603 to add the content. This information can then be stored in association with a world model based on the point. Moreover, metadata can be associated with the stored information. The metadata can be presented in another portion 605 of the user interface 600. For example, the metadata may include a street location of the view. Moreover, the metadata may include other information about the view, such as a floor associated with the point. In certain embodiments, the floor can be determined based on the virtual model, which may include floor information. Other detailed information associated with objects such as buildings may further be included in a description of the object and used for determining one or more points to associate content with objects.

In certain embodiments, the user can select a telescopic feature 607 which allows the user to browse the current surroundings to change views. For example, the user may select the telescopic feature 607 to be able to see additional information associated with a panoramic image and/or virtual model. The telescopic feature may additionally allow the user to browse additional views or perspectives of objects. Moreover, the user can select a filtering feature 609 that may filter content based on criteria as previously detailed. The user can add additional content or comment on content via a content addition feature 611. The user can select a point on the user interface 600 to add the content. Other icons may be utilized to add different types of content. Further, the user may switch to a different mode (e.g., a full screen mode, a map mode, a virtual world mode, etc.) by selecting a mode option 613.

FIG. 6B shows an example user interface 620 showing content 621. In certain embodiments, the content 621 can be associated with a billboard spot on a building of the physical world. The billboard spot may include one or more advertisements. Further, the advertisement content can be sold to advertisers. Moreover, if the user does not like the advertisement, the user can filter the advertisement and be shown a different advertisement. Further, the user may comment 623 on the advertisement or other content. Comments from other users may additionally be provided to the user. In certain embodiments, as shown, the content 621 fits to the form of the object, in this case a building object 625. FIG. 6C shows the content 641 after a change in the content on a user interface 640. Further, a visual cue may be selected and/or presented with commentary 643. Commentary 643 can be scrolled through or otherwise viewed based on user input or time.

FIG. 6D shows another example user interface 660 showing a view of content 661 between two objects 663, 665. In this example, the content 661 can be tied to one or more objects. The content 661 can start at a first point 667 and be created based on that first point 667. Further, the content 661 can be associated with another point 669. Thus, content 661 can be associated with more than one point. This allows for searching for the content 661 based on one or more different objects that can be associated with the content 661. In certain embodiments, one or more tools can be provided to the user to add or annotate content. For example the tools can include libraries of objects such as 3D objects, 2D objects, drawing tools such as a pencil or paintbrush, text tools to add text, or the like. Further, one or more colors can be associated with content to bring attention to the content.

With the above approaches, content associated with physical environments are able to be annotated and presented in a precise and integrated manner. Location based content can become part of the environment instead of a layer from a map or camera view interface. In this manner, the user is able to interact directly with objects, such as building walls, and with content attached to those object (e.g., walls). Further, this approach allows for the presentation of additional content in what could be a limited sized screen because content is annotated to the objects. Precision in determining where to place the content can be accomplished by associating the content to the objects in a 3D environment. As previously noted, a 3D environment can include a database with objects corresponding to three dimensions (e.g., an X, Y, and Z axis).

The processes described herein for annotating and presenting content may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

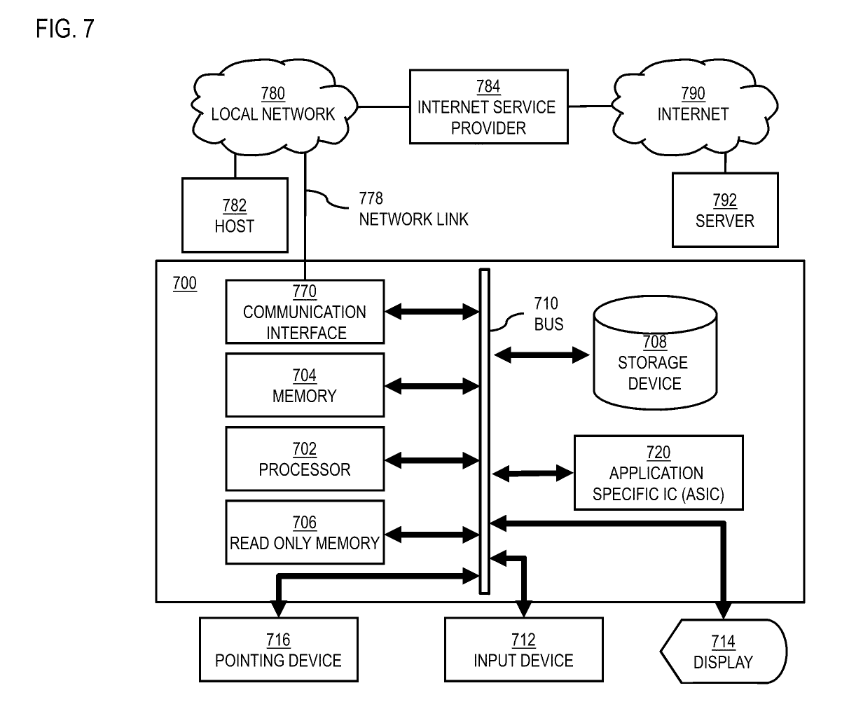

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to annotate and present content as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of annotating and presenting content.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to annotating and presenting content. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for annotating and presenting content. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for annotating and presenting content, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for communication to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to annotate and/or present content as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of services. Chip set or chip 800, or a portion thereof, constitutes a means for performing one or more steps of annotating and presenting content.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to annotate and/or present content. The memory 805 also stores the data associated with or generated by the execution of the inventive steps.

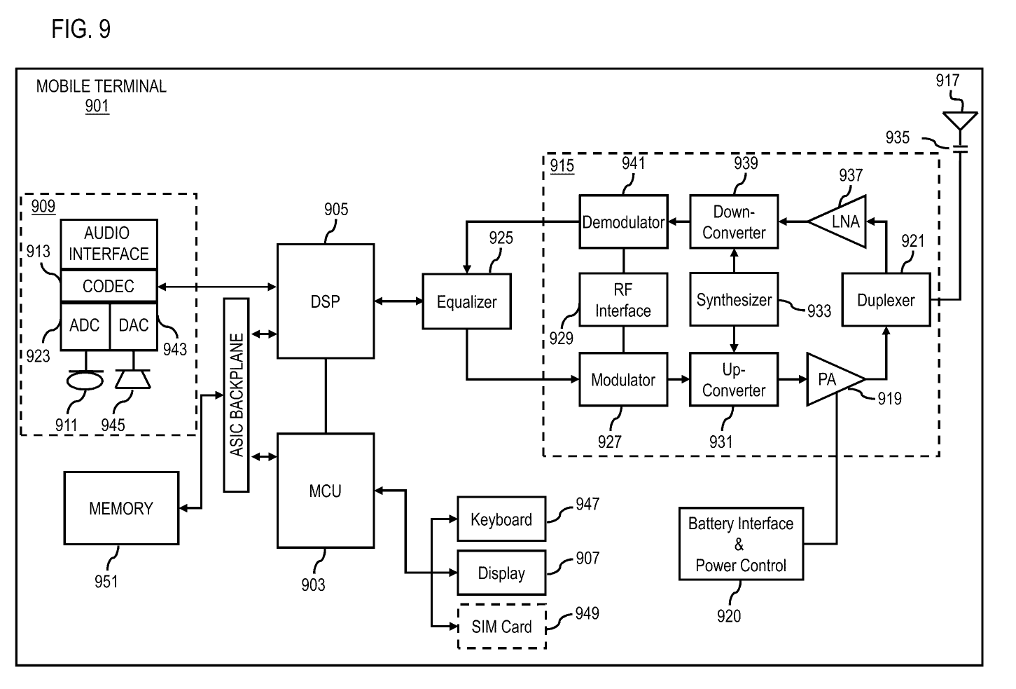

FIG. 9 is a diagram of exemplary components of a mobile terminal or station (e.g., handset) for communications, which is capable of operating in the system of FIG. 1, according to one embodiment. In some embodiments, mobile terminal 901, or a portion thereof, constitutes a means for performing one or more steps of annotating and presenting content. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of annotating and presenting content. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903—which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to annotate and/or present content. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
retrieving content associated with one or more points of one or more objects of a location-based service;
retrieving one or more models of the one or more objects; and
causing, at least in part, rendering of the content associated with one or more surfaces of the one or more object models in a user interface of the location-based service.

2. A method of claim 1, further comprising:
receiving an input for selecting the one or more points via the user interface;
associating the content with the one or more points; and
causing, at least in part, storage of the association of the content and the one or more points.

3. A method of claim 1, further comprising:
receiving an input for manipulating the rendering of the content; and
causing, at least in part, update of the content, the one or more points, the one or more object models, an association between the one or more points and the content, or a combination thereof.

4. A method of claim 1, wherein the one or more object models, one or more other object models, or a combination thereof comprise a three-dimensional model corresponding to a geographic location, the method further comprising:
causing, at least in part, rendering of one or more images over the three-dimensional model in the user interface.

5. A method of claim 4, wherein the images include panoramic images, augmented reality images, mixed reality images, virtual reality images, or a combination thereof.

6. A method of claim 1, further comprising:
determining a perspective of the user interface;
determining whether the rendering of the content is obstructed by one or more renderings of other object models in the user interface; and
recommending another perspective based, at least in part, on the determination with respect to the obstruction.

7. A method of claim 1, further comprising:
causing, at least in part, filtering of the content, the object model, the point, one or more other object models, one or more other content, or a combination thereof based, at least in part, on one or more criteria; and
causing, at least in part, rendering of the user interface based, at least in part, on the filtering.

8. A method of claim 1, further comprising:
determining one or more three-dimensional coordinates for rendering the content relative to one or more other three-dimensional coordinates corresponding to the one or more object models.

9. A method of claim 8, further comprising:
associating the content with the one or more object models, the one or more points, one or more other points within a volume of the one or more objects, or a combination thereof based, at least in part, on the one or more three-dimensional coordinates.

10. A method of claim 1, further comprising:
determining a perspective of the user interface;
determining a view of the content based on the perspective; and
causing, at least in part, a transformation of the rendering of the content based on the view.

11. An apparatus comprising:
at least one processor; and
at least one memory including computer program code for one or more programs,
the at least one memory and the computer program code configured to, with the at least one processor, cause the apparatus to perform at least the following,
retrieve content associated with one or more points of one or more objects of a location-based service;
retrieve one or more models of the one or more objects; and
cause, at least in part, rendering of the content associated with one or more surfaces of the one or more object models in a user interface of the location-based service.

12. An apparatus of claim 11, wherein the apparatus is further caused to:
receive an input for selecting the one or more points via the user interface;
associate the content with the one or more points; and
cause, at least in part, storage of the association of the content and the one or more points.

13. An apparatus of claim 11, wherein the apparatus is further caused to:
receive an input for manipulating the rendering of the content; and
cause, at least in part, update of the content, the one or more points, the one or more object models, an association between the one or more points and the content, or a combination thereof.

14. An apparatus of claim 11, wherein the one or more object models, one or more other object models, or a combination thereof comprise a three-dimensional model corresponding to a geographic location, and wherein the apparatus is further caused to:
cause, at least in part, rendering of one or more images over the three-dimensional model in the user interface,
wherein the images include panoramic images, augmented reality images, mixed reality images, virtual reality images, or a combination thereof.

15. An apparatus of claim 11, wherein the apparatus is further caused to:
determine a perspective of the user interface;
determine whether the rendering of the content is obstructed by one or more renderings of other object models in the user interface; and
recommend another perspective based, at least in part, on the determination with respect to the obstruction.

16. An apparatus of claim 11, wherein the apparatus is further caused to:
cause, at least in part, filtering of the content, the object model, the point, one or more other object models, one or more other content, or a combination thereof based, at least in part, on one or more criteria; and
cause, at least in part, rendering of the user interface based, at least in part, on the filtering.

17. (canceled)

18. A computer-readable storage medium carrying one or more sequences of one or more instructions which, when executed by one or more processors, cause an apparatus to at least perform the following steps:
retrieving content associated with one or more points of one or more objects of a location-based service;
retrieving one or more models of the one or more objects; and
causing, at least in part, rendering of the content associated with one or more surfaces of the one or more object models in a user interface of the location-based service.

19. A computer-readable storage medium of claim 18, wherein the apparatus is caused to further perform:
receiving an input for selecting the one or more points via the user interface;
associating the content with the one or more points; and
causing, at least in part, storage of the association of the content and the one or more points.

20. A computer-readable storage medium of claim 18, wherein the apparatus is caused to further perform:
receiving an input for manipulating the rendering of the content; and
causing, at least in part, update of the content, the one or more points, the one or more object models, an association between the one or more points and the content, or a combination thereof.

21. A method of claim 1, wherein the one or more object models, one or more other object models, or a combination thereof represent one or more corresponding buildings, the method further comprising:
associating the one or more points with a floor of one of the one or more corresponding buildings;
receiving an input for selecting the one or more points via the user interface, wherein the content is associated with the floor.
